(19) United States
(12) Patent Application Publication
(10) Pub. No.: US 2019/0347626 A1
(43) Pub. Date: Nov. 14, 2019

(54) SYSTEM FOR OFFLINE PAYMENT WITH E-MONEY USING A MOBILE DEVICE WITH A SHORT TRANSACTION TIME AND FINAL SETTLEMENT

(71) Applicant: PBV KAUFMANN SYSTEME GMBH, Reiden (CH)

(72) Inventors: Stephan WULLSCHLEGER, Olten (CH); Markus KNECHT, Brugg (CH); Dominik GRUNTZ, Wettingen (CH); Christof ARNOSTI, Basel (CH)

(73) Assignee: PBV KAUFMANN SYSTEME GMBH, Reiden (CH)

(21) Appl. No.: 16/464,809

(22) PCT Filed: Dec. 15, 2017
(86) PCT No.: PCT/EP2017/082995

§ 371 Date: May 29, 2019

(30) Foreign Application Priority Data
Dec. 20, 2016 (EP) 16205267.4

(51) Int. Cl. G06Q 20/06; G06Q 20/32; G06Q 20/36

(52) U.S. Cl. CPC G06Q 20/065; G06Q 20/3678; G06Q 20/3674; G06Q 20/3278

(57) ABSTRACT

A system for secure payment with electronic money using a mobile device, in particular using a non-secure mobile device (2) without a suitable security element, to the electronic money. In addition is a method for secure payment with electronic money as well as to the use of the method.

### CROSS REFERENCE TO RELATED APPLICATION

This application is a national stage entry of PCT/EP2017/082995 filed Dec. 15, 2017, under the International Convention claiming priority over European Patent Application No. 16205267.4 filed Dec. 20, 2016.

### TECHNICAL FIELD

The present invention relates to a system for secure payment with electronic money using a mobile device, in particular using a non-secure mobile device (2) without a suitable security element, to the electronic money, to a method for secure payment with electronic money as well as to the use of said method.

### BACKGROUND OF THE PRIOR ART

Cashless payment of goods is becoming increasingly important. In particular when paying smaller amounts of money, the cashless payment has large advantages compared to cash. For example, the costs for managing cash, such as personnel costs, transport costs, insurance costs, and maintenance costs, are eliminated for the trade. When paying, change is also no longer necessary, because the exact amount is always deducted from the card. These aspects are also of increasing significance when paying small amounts and very small amounts, in the case of vending and in the event sector.

Different means of payment for cashless payment are known, wherein the credit card payment and the debit card payment are the most well-known.

In the case of a debit card payment, payment can be made at a payment terminal, in that the corresponding amount of money is charged directly to the checking account associated with the debit card at a financial institution and is credited to the seller's checking account. The debit card is thereby linked directly to a specific checking account, and the payment terminal needs to be connected to a payment service provider, PSP, during the payment transaction, i.e. needs to be online. No money is thus stored on the debit card, but the card serves only to identify the user. No offline payments can be made.

In the case of the credit card payment, the payed amount is initially charged to a credit institution. The credit institution then demands the amount from the buyer afterwards. In the case of this payment type, money is thus also not stored on the card. To prevent misuse, the payment terminal also needs to be connected to the payment service provider during the payment transaction, i.e. needs to be online. Offline, credit card payments can only be made provisionally and only if they are accepted by the credit institution as well by the vendor, i.e. provider or seller, respectively. An offline payment, which is not binding yet, however, is thus made temporarily. A definitive payment with final and thus binding settlement can only take place when the payment has been verified online by one or several servers and/or people. To compensate for an associated increased non-payment risk, the transaction fees are correspondingly higher in the case of credit card payments.

Cashless payment by means of debit cards and credit cards have established themselves in many spheres of life and appear to be indispensable. It thus does not come as a surprise that, in recent times, there are various approaches to bring debit card and credit card payment methods to the mobile telephone. This is so, because the mobile telephone is usually at hand and rarely gets lost. And generally speaking, it can be located or remotely blocked quickly, if lost. The access to one's own mobile telephone is also protected, for example, by means of a secret access code. In addition, no money is stored on the mobile telephone, which ensures a certain security against counterfeiting and misuse. This is so, because this security is ensured by a central server of financial and credit institutions, in particular in the case of debit card and credit card payment methods.

Different types of crypto currencies, such as Bitcoin, for example, have also been circulating for several years. These crypto currencies are not stored on a device, such as, for example, a mobile telephone—not least in order to meet high security demands—but in a decentralized network, in which—put simply—all subscribers of the network communicate with one another and establish consensus as to who has how much money at what time. In order to thus be able to pay with a crypto currency, a device involved in the payment must be online, i.e. must have a contact to at least one server. In order to ensure the security of the crypto currency, every transaction is thus verified and authorized by a plurality of further devices, with which payment can typically be made using the same crypto currency. Such a verification is extremely complex and currently takes approximately ten minutes or more, for example in the case of Bitcoin. In addition, each of these products, such as Bitcoin, forms its own, specific currency, wherein the exchange rate to country currencies can change as well. Depending on the current trust in the respective product, the exchange rate can fluctuate greatly within a short time. Due to the fact that the seller as well as the buyer generally want payment security and do not want to be part of currency speculation, such products are unsuitable in particular for paying small amounts. In addition, offline payments, in particular a transfer of e-money with final settlement without connection to the Internet at the time of the payment cannot take place with products, such as Bitcoin, due to the lack of mutual trust between buyer and/or seller.

In the case of all of these above-mentioned cashless payment systems, an Internet connection is suggested or is even indispensable at the time of the payment transaction and is required more and more frequently by the operators. If no Internet connection is available, however, at the time of the payment transaction—for example in a mobile hole or in the case of sudden failure of the Internet—the payment transaction cannot be performed in the extreme case.

If a monetary value, and thus money, is electronically stored on a portable medium, e.g. on a smartcard, this is referred to as electronic money, also called e-money.

In the case of an e-money card, also called prepaid card or value card, an amount of money is electronically stored directly on the card. In response to a payment transaction, the corresponding amount is then withdrawn directly from this card. The user can subsequently deduct money from such a prepaid card, in order to make purchases, until the amount of money is used up. Due to the fact that the credit standing of the buyer, i.e. of the user of the prepaid card, is satisfactory in the case of payments with a prepaid card, no or only very small transaction fees are incurred, which is generally advantageous for the buyer as well as for the seller. In contrast to the debit cards and credit cards, payments can be made even at payment terminals, which are offline at the time of the payment transaction, or which are not connected to the Internet or a central server, respectively. The significance of such offline payments, thus payments, in the case of which the money-giving as well as the money-accepting medium are offline and are not connected to the Internet, must not be underestimated. For example, in the vending sector, the vending machines and the payment terminals thereof are only very rarely equipped with a link to the Internet. Payment systems on the basis of e-money or prepaid cards, respectively, are also comparatively cost-efficient for the buyer compared to payment systems on the basis of debit cards and in particular credit cards, because non-negligible fees are incurred with each payment transaction using debit card and credit card. The costs for the required infrastructure for debit and credit cards and the maintenance thereof should also not be underestimated, whereby the fees are further increased.

A central point in the case of electronic payment methods, such as payments with a prepaid card, is the security against theft, counterfeiting, and misuse. While the user is used to taking care of his belongings, not least because of the use of cash, theft of e-money is much more difficult to detect. Counterfeiting and misuse of e-money are also much more difficult to detect. So that the payment by means of a prepaid card with e-money can gain the trust of financial institutions and of users and can thus become accepted, the e-money, however, must have a very high level of counterfeiting and misuse security.

In order to ensure the necessary security against counterfeiting and misuse, prepaid cards comprise a security element. Such cards are also called smartcards. They are relatively expensive and are generally issued by a trusted source, for example a trusted partner of a financial institution. In order to additionally increase the security of such prepaid cards, they are often only valid for a limited time and are usually limited to certain points of sale. The managing of prepaid cards is also relatively complex for an operator of points-of-sale with prepaid cards. And the user cannot readily inquire about the current balance on a prepaid card. In addition, he often owns various prepaid cards, which is perceived to be confusing and disadvantageous.

It is not very surprising for the above-mentioned reasons, when the user expresses the desire to be able to also make payments analogously with a prepaid card using his mobile telephone. This is so, because he can then also pay small amounts, as in the case of machine vending and in the event sector, without cash without any problems, when he can use his mobile telephone like a prepaid card. So that such a mobile telephone-based prepaid card has all of the advantages of a normal prepaid card, it is central that payments can also be made with it, when the mobile telephone does not have an Internet connection at the time of the payment transaction, i.e. that payments can also be made offline with the mobile telephone-based prepaid card.

In order to provide a mobile telephone-based prepaid card, an amount of money thus needs to be electronically stored directly on the mobile telephone. Mobile telephones, however, are considered to not be secure, i.e. the security standard for mobile telephones is considered to be unsatisfactory in particular with regard to e-money, because the counterfeiting and misuse security of e-money cannot be ensured on all mobile telephones. Mobile telephones per se are thus unsuitable for securely storing electronic money on them. With today's available technologies, it is thus not possible to provide mobile telephone-based prepaid cards, which meet the required security standards, without installing the prepaid card itself or an equivalent hardware directly into the mobile telephone or using corresponding available hardware in the mobile telephone, respectively.

The use of a specific security element, which is designed for offline payments with e-money, is essential with today's technologies in order to provide a device, such as a mobile telephone, with sufficient security properties for the e-money stored on the device. Compared to equivalent prepaid cards, these security elements are relatively expensive and not every mobile telephone can even be retrofitted with a corresponding security element. Even though some mobile telephones of the most recent generation have security elements, by means of which, for example, input credit card data can be securely stored, the access to possibly available security elements is limited or completely barred for the most part.

TABLE A
Known electronic means of payment and object of the invention with regard to the manner of the
money transfer, storing e-money as well as offline payment options. All mentioned means of payment
are widespread and are generally accepted by credit institutes, banks and the users.

| | | E-money (4) ^{b)} | Security element | | |
|---|---|---|---|---|---|
| | Money transfer | in the carrier of | SE in the carrier | Offline | Money slippage ¹⁾ |
| Electronic means of | in response to | the means of | of the means of | payment | can be ruled |
| payment | payment transaction | payment | payment? | possible? | out? |
| e-banking ^{a)} | K↔K^{c)} | no | N/A | no | yes |
| debit card ⁱ⁾ | K↔K^{c)} | no | type 1^{d)} | no | yes |
| credit card ^{j)} | K↔K^{c)} | no | no ^{k)} | tempⁱ⁾ | online: yes |
| | | | | | offline: no |
| crypto currency ^{e)} | K↔K^{c)} | no | no ^{k)} | no | yes |
| prepaid card | GK↔T^{g)} | yes | type 2^{h)} | yes | no |
| object of the invention | G↔T^{g)} | yes | no ^{k)} | yes | yes |

a) E-banking is understood in the broader sense, i.e. software tools for managing proprietary network credit balance and the like are also included in addition to online banking systems for detecting carryovers between banknotes.
b) E-money (4) comprises any electronic e-money.

c) K↔K stands for account↔account, i.e. from account to account. A money transfer in response to a payment transaction from account to account means that the money is transferred from an account of a financial institution to another account of the same or another financial institution, whereby the money can possibly also be transferred via interim accounts.

d) A type 1 security element SE allows to securely store keys and data, such as a PIN code and information relating to the card, i.e. relating to the means of payment, as well as to carry out crypto algorithms in a secure environment (see Table D). This is indispensable today for the core object of a debit card, the withdrawal of cash at an automated teller machine.
e) A known crypto currency is Bitcoin.
f) A prepaid card is understood to be a smartcard, on which e-money can be stored.
g) GK↔T stands for transfer between prepaid card and terminal, and G↔T stands for transfer between device and terminal. The money transfer to the prepaid card or to the device, respectively, is not listed.
h) In addition to the functionality of a type 1 SE, a type 2 security element SE also allows the storing of e-money (see Table D).
i) Temporarily means that a payment can take place temporarily, but that it is not yet binding. A final and thus binding settlement can only take place when the payment has been verified online by one or several servers and/or persons.
j) The differentiation between debit card and credit card is made here in order to differentiate the means of payment. Today, modern payment cards often perform the tasks of both card types. Depending on selected payment methods, it is either used as credit card or as debit card. The properties of the card types are thus also maintained as hybrid.
k) A security element SE is not necessary for the integrity and the protection of the system (1) according to the invention. To protect the private data or one's own money against theft, e.g. by means of malicious software, a type 1 security element SE 1 can be used.
l) Money slippage is understood that money gets lost in error or is credited twice in response to a money transaction.

It is thus the object of the present invention to provide a system for secure cashless payment by means of a mobile telephone-based payment card, wherein the payment transaction with final settlement can also be made without Internet connection and thus offline, i.e. without mobile radio and/or Internet connection at the time and at the location of the payment transaction. The money stored on the mobile telephone needs to have a very high counterfeiting, misuse and payment security and needs to essentially be available in that country currency, which is common at the location of the payment transaction. The mobile telephone should nonetheless not need to meet any specific security demands, i.e. cashless payment is to also be possible with so-called non-secure devices. The cashless payment needs to be capable of being processed quickly in each case, i.e. needs to have a short transaction time, so that the system is accepted by its users. The cashless payment is to also include a final settlement in all cases, so that it is accepted accordingly by the terminal operators and thus by the points of sale. In addition, the system is to prevent the money slippage, i.e. the erroneous loss or double crediting of money.

### SUMMARY OF THE INVENTION

Surprisingly, it was possible to solve this complex and challenging object by means of a system (1) for secure payment with electronic money (4), i.e. e-money (4), comprising
at least one mobile device (2) with e-money, wherein the e-money (4) is possibly managed by means of software,
possibly at least one smartcard (6) with e-money (4), wherein e-money (4) is kept on the smartcard (6),
at least one payment terminal (5), and
at least one server (7),
characterized in that

I. the e-money (4) is available as e-money (4*), wherein the e-money (4*) comprises at least one load token TL (41) and, after a first payment transaction, also at least one spend token TS (41), which differs from the load token TL (41), and/or

II. the terminal (5) comprises at least one security element SEALS-SE (3), wherein the security element SEALS-SE (3) is suitable for keeping and transferring e-money (4, 4*) with final settlement even using a device (2) without security element SE and without Internet connection at the time of the payment transaction, and the terminal (5) and the device (2) do not need to be connected to the server (7) for a final settlement at the time of a payment transaction and may therefore be offline.

What is also claimed is electronic money (4*) for secure payment using the device (2), in particular using the non-secure device (2), at a terminal (5) according to system (1), characterized in that the e-money (4*) comprises at least one load token TL (41) and, after a first payment transaction, also at least one spend token TS (42), which differs from the load token TL (41), wherein:

the load token TL (41) is stored on the device (2) and comprises at least the amount of a credit of the e-money (4*) stored on the device (2),
the spend token TS (42) comprises at least the value of the goods of the goods purchased/sold in response to the payment transaction and possibly additional information relating to the payment transaction, in particular relating to the device (2) and terminal (5) involved in the payment transaction, and thus represents a payment transaction with e-money (4*) from the device (2) to the terminal (5), wherein the spend token TS (42) is stored at least on the device (2) and/or terminal (5), and
the current value of the e-money (4*) stored on the device (2) is represented by the sum of the load tokens TL (41) minus the sum of the spend tokens TS (42), wherein the at least one load token TL (41) and the possibly at least one spend token TS (42) preferably includes information, which allows a chronological arrangement.

What is also claimed is a method for secure payment with e-money (4, 4*) using the device (2) with the system (1) according to the invention, wherein the method comprises at least one of the following steps a) to d):

a) storing e-money (4) on the device (2) and/or a terminal (5), wherein the e-money (4) comprises at least one load token TL (41) and, after a first transaction, also at least one spend token TS (42),

b) a payment transaction with e-money (4, 4*) with final settlement without Internet connection at the time of the payment transaction comprising a transaction of a credit balance from device (2) to terminal (5) and/or from terminal (5) to device (2), wherein the terminal (5) comprises at least one physical security element SEALS-SE (3), the device (2) and the terminal (5) communicate with one another, and the transaction of the credit balance is preferably represented in at least one spend token TS (42),

c) the exchange of at least one telegram between terminal (5) and server (7) and/or between server (7) and terminal (5), wherein the exchange of the at least one telegram takes place via the device (2) and/or a plurality of devices (2″), and/or

d) the monitoring and detecting of misuse in the system (1) with e-money (4, 4*), wherein
the server (7) stores, processes the telegrams received by the devices (2, 2″), possibly blocks at least one device (2, 2″) for the system (1), and transfers other telegrams via the devices (2, 2″) to the terminal (5), and/or
the terminal (5) verifies at least the spend tokens TS (42) received from the devices (2, 2″) using the security element SEALS-SE (3) with regard to the correctness thereof, possibly blocks and/or rejects at least one device (2, 2″) for the system (1), and possibly transfers at least one telegram via the devices (2, 2″) to the server (7),

e) and possibly a buy-back of the e-money (4, 4*) accumulated at the terminal (5) with money transfer to the seller's bank account.

What is additionally claimed is a method for secure cashless payment with the electronic money (4*) according to the invention using the device (2) at a terminal (5), characterized in that the e-money (4*) comprises at least one load token TL (41) and, after a first payment transaction, also at least one spend token TS (42), which differs from the load token TL (41), wherein
the load token TL (41) is stored on the device (2) and comprises at least the amount of a credit balance of the e-money (4*) stored on the device (2),
the spend token TS (42) comprises at least one value of the goods of the goods purchased/sold in response to the payment transaction and possibly additional information relating to the payment transaction, in particular relating to the device (2) and terminal (5) involved in the payment transaction, and thus represents a payment transaction with e-money (4*) from the device (2) to the terminal (5), wherein the spend token TS (42) is stored at least on the device (2) and/or terminal (5), and
the current value of the e-money (4*) stored on the device (2) is represented by the sum of the load tokens TL (41) minus the sum of the spend tokens TS (42), wherein the at least one load token TL (41) and the possibly at least one spend token TS (42) preferably includes information, which allows a chronological arrangement.

What is also claimed is the use of the system (1) according to the invention and the method according to the invention for secure payment with e-money (4) using the device (2) even if the device (2) and the terminal (5) have no contact to the server (7) during the payment transaction and are thus offline.

What is also claimed is the use of a physical safety element SEALS-SE (3) for offline payments with e-money (4) at a terminal (5) for secure payment with e-money (4) using the device (2) at a terminal (5) with the system (1) according to the invention and the method according to the invention, wherein the security element SEALS-SE (3) is suitable for keeping and transferring e-money with final settlement even using a device (2) without security element SE and without Internet connection at the time of the payment transaction, wherein the payment transaction can also take place when the device (2) and the terminal (5) have no contact to the server (7) during the payment transaction and are thus offline.

### BRIEF DESCRIPTION OF THE DRAWINGS

FIG. 1 shows, in an exemplary manner, a server (7), two different types of terminals (5), both of which have a security element SEALS-SE (3) for offline payments with e-money from a device (2) and/or a smartcard (6), and represent a vending machine or a terminal (5), respectively, at a cash register, as well as the devices (2), (2′) and (2″);

FIG. 2 shows, in an exemplary manner that a) a device (2) with the terminal (5) can process a payment transaction with final settlement offline, i.e. without connection to the sever;

FIG. 3 shows, in an exemplary manner, a) an offline payment transaction with final settlement at the terminal (5) with a smartcard (6), which cannot establish a connection to the server (7) and is thus permanently offline;

FIG. 4 shows, in an exemplary manner, an offline payment transaction at the terminal (5) using a device (2), which a) is offline, because the terminal and the device (2), for example, are in a dead spot or in a basement without Internet connection; and

FIG. 5 shows, in an exemplary manner, e-money (4, 4*) according to the invention and preferably used according to the invention, which is stored on a device (2) and comprises at least one load token TL (41) and, after a first payment transaction, also at least one spend token TS (42), which differs from the load token TL, wherein

### DETAILED DESCRIPTION OF THE INVENTION

With the system (1) according to the invention comprising e-money (4, 4*), the e-money (4*) according to the invention, the method according to the invention, and the uses according to the invention, cashless payment with e-money (4, 4*) can surprisingly not only be made online, but also offline, i.e. also at locations with e-money (4, 4*), which do not have a mobile phone and/or Internet connection, using a non-secure mobile device (2), such as, for example, using a mobile telephone without security element SE. The non-secure mobile telephone can thus be used, for example, as device (2) as secure prepaid card, with which payment can also be made offline. Instead of—or also in addition—to non-secure devices (2), mobile devices (2), which comprise a security element SE and which are thus considered to be secure, can furthermore also be used in the system (1). In addition, the e-money (4*) of the present invention and the e-money (4) preferably used in the system (1) according to the invention has a very high counterfeiting, misuse and payment security. The payment transaction with the e-money (4) can nonetheless be processed quickly—and preferably also in a contactless manner, even if the devices, which are relevant for a payment transaction, such as the device (2), i.e. for example the mobile telephone, and the terminal (5), i.e. for example the point-of-sale (POS) at a cash register or a vending machine are offline at the time and/or at the location of the payment transaction. An imperative and final settlement of the payment transaction is thus surprisingly attained by means of the system (1) according to the invention in the case of cashless payment in all cases, in particular even if the device (2) as well as the terminal (5) are offline.

TABLE B
The present invention as compared to known electronic means of payment in the case
of online payments with regard to the use of e-money (4), security elements SE in the
means of payment and in the terminal (5) as well the respective transaction time.

| | E-money (4) ^{b)} | Security element, | | |
|---|---|---|---|---|
| | in the carrier of | SE in the carrier | Security element | |
| Electronic means of | the means of | of the means of | SE in the | Transaction |
| payment ^{a)} | payment? | payment? | terminal? | time ^{c)} |
| e-banking ^{d)} | no | N/A | N/A | N/A |
| debit card | no | type 1 ^{e)} | no | <5 sec. |
| credit card | no | no ^{f)} | no | <5 sec. |
| crypto currency | no | no ^{f)} | no | <2 min. |
| prepaid card | yes | type 2 ^{g)} | no | <5 sec. |
| non-secure device (2) | yes | no ^{f)} | type 3 ^{h)} | <5 sec. |
| according to the invention | | | | |

a) See Table A.

b) See Table A.

c) The transaction time is the time until a payment transaction has been carried out temporarily or definitively, i.e. finally, at the point-of-sale, e.g. at the terminal (5).

d) E-banking with mobile telephone without security element SE, i.e.

using a non-secure device (2), can only be performed online due to known, individual authorizations. The transaction time of a payment transaction cannot be compared to the transaction time of the other listed means of payment. Depending on implementation, the transaction can take a few seconds to several days.

e) A type 1 security element SE allows to store the cryptographic key and data, such as, for example, information relating to the card (see Table D).

f) See Table A, footnote k).

g) In addition to storing the cryptographic key and data, a type 2 security element SE additionally allows to store e-money (see Table D).

h) According to the invention—in addition to the abilities of a type 2 SE—a type 3 security element SE also allows to keep e-money in a means of payment without SE, i.e. device (2) and to transfer e-money from a means of payment without SE, i.e. device (2), to a terminal, i.e. terminal (5), wherein only the terminal (5) imperatively requires such a security element SE. security element SEALS-SE is a type 3 security element SE suitable for this purpose (see Table D).

In addition, the e-money (4, 4*) according to the present invention may not only be available in any country currency, but the e-money (4, 4*) can also simultaneously be stored in different country currencies as well as complementary currencies on the same device (2). Surprisingly, the system (1) according to the invention, the method according to the invention, as well as the use according to the invention can also be enhanced with a smartcard (6), wherein only the latter and not the device (2) itself needs to be carried along. This can be very useful for example for users, who are on company premises and want to pay with e-money (4, 4*) at vending machines and/or in the cafeteria during this time.

In addition, the present invention allows that the e-money (4) stored on the device (2) can be viewed and/or managed on the display with input field of the device (2). Withdrawal limits can thus also be defined for example by means of suitable software.

It can be seen clearly from Tables A, B, and C that the system (1) of the present invention surprisingly integrates the advantages of the prepaid card into mobile telephones, and thus into existing mobile devices (2). The mobile device (2) in particular does not need a security element SE in order to also attain a final settlement offline within a maximum of few seconds in response to a payment transaction. E-money (4, 4*) can nonetheless be stored on the device (2), which is thus non-secure, and payment can be made therewith at a terminal (5). A payment transaction can thus not only be completed online, but also offline with the system according to the invention, i.e. the settlement is also performed offline and thus without Internet connection so as to be final. In contrast, only a temporary settlement can be performed offline with crypto currencies, analogously to credit cards. To compensate for the increased failure risk associated therewith, the transaction fees are correspondingly higher. In the case of crypto currencies, the transaction time, i.e. the time until a payment transaction has been completed, is typically also more than 5 minutes, and is thus much longer than in the case of the present invention.

TABLE C
Compared to known electronic means of payment, the present invention in the case
of offline payments with regard to the use of e-money (4), security elements SE
in the means of payment and in the terminal (5), as well as offline settlement.

| | | e-money (4) ^{b)} | Security element | | |
|---|---|---|---|---|---|
| | Offline | in the carrier of | SE in the carrier | Security element | |
| Electronic means of | payment | the means of | of the means of | SE in the | Final settlement |
| payment ^{a)} | possible? | payment? | payment? | terminal? | possible offline? |
| E-banking | Offline payment not possible | | | | |
| Debit card | Offline payment not possible | | | | |
| Credit card | temp ^{e)} | No | no ^{f)} | no | no ^{g)} |
| Crypto currency | Offline payment not possible | | | | |
| Prepaid card | yes | yes | type 2 ^{d)} | type 1 or | yes ^{h)} |
| | | | | type 2 | |
| Non-secure | yes | yes | No | type 3 ^{c)} | yes ^{h)} |
| device (2); | | | | | |
| according to | | | | | |
| invention | | | | | |

a) See Tables A and B.

b) See Tables A and B.

c) See Table B, footnote h).

d) See Table B, footnote g).

e) Temporarily means that a payment can take place temporarily offline, but is not yet binding. A final and thus binding settlement can only take place when the payment has been verified online by one or several servers and/or persons. Crypto currencies act similarly as credit cards in response to offline payment transactions.

f) See Table A, footnote k).

g) If there is no offline settlement, the electronic means of payment needs to have an Internet connection at the time of the payment transaction, or —if possible—a temporary offline payment takes place and thus a temporary settlement offline, which needs to be confirmed at a later time in order to attain a final settlement.

h) In response to a payment transaction with the corresponding means of payment, the money is debited directly from a credit balance and is credited to a different credit balance (see Table A, footnote g).

It was surprisingly also found that the money slippage in response to transactions can be prevented completely with the e-money (4*) according to the invention, because the spend token TS (42) is typically stored on the device (2, 2″) as well as on the terminal (5) in the form of an identical copy in response to a payment transaction. If the spend token TS (42) is erroneously not stored or is not stored correctly on the terminal (5), this is transmitted in response to a next interaction at the same terminal (5). The spend token TS (42) remains stored on the device (2, 2″) until a further contact, and can be recognized as non-concluded withdrawal and as being reserved for the terminal (5). Should the terminal (5) receive a spend token (42) several times, it is nonetheless only used exactly once.

US-A-2016224977 describes a method, by means of which a first token is received by a first, in particular mobile device, wherein the first token is associated with an amount of money and a start date with regard to the availability of the amount of money. After the first token has been received by the first device, the first device creates a second token, which is connected to the first token and the creation date of the second token, wherein the first device provides the second token and the creation date of the second token to a second, in particular mobile device. The mobile devices are connected to a server of the service provider, wherein said server, in turn, communicates with a processing network.

The processing network communicates with an authorization server, which authorizes new tokens. The tokens on the devices represent a type of check, i.e. check, which can be transferred to a further device as a whole or in parts in the form of a second or further token. Relevant information relating to each token is stored in a separate storage room, which is independent of the device, for example a vault, or is input into a central public register. Payments can be made with the tokens, i.e. checks, at a computer of a merchant. The mobile device can be offline for this purpose. The merchant computer, however, needs to imperatively be online at the time of the transaction, and needs to be in synchronous communication with the processing network and thus with the storage room or the public register, in order to confirm that the token is covered sufficiently and belongs to the payor. A token thus does not include electronic money and also does not represent a prepaid card, but a token represents money in the form of a check, which is kept on a central server, such as the authorization server. If a token is transferred to a new device, this is also input in the public register. A token thus authorizes the collection of money, but is not money itself. In addition, the first and the second token do not differ in the setup and in the purpose of the tokens, but only include other information. Real offline payments without Internet connection cannot be made, because at least the merchant computer needs to have an active connection to the processing network, because an external server validates a payment, i.e. performs a final settlement. External networks, servers and computers are essential for the completion of a payment and for the definitive settlement of the payment. The mobile device typically has a security element SE, but not the merchant computer.
The system (1)

The system (1) according to the invention and the system (1) used in the method according to the invention for secure payment with e-money (4) comprises
at least one mobile device (2) with e-money (4), wherein the e-money (4) is stored on the device (2) and is possibly managed by means of software,
possibly at least one smartcard (6) with e-money (4), wherein e-money (4) is kept on the smartcard (6),
at least one payment terminal (5), and
at least one server (7).

Secure as well as non-secure mobile devices (2) can be used in the system (1) according to the invention. Secure devices (2) are understood to be devices (2), which include a type 2 or type 3 security element SE, which is available for securely keeping and transferring e-money and thus for offline payments with e-money and which is approved for use by third parties. Non-secure devices (2) accordingly do not have a suitable security element SE or the available suitable security element SE is not available for use, respectively.

According to the invention, the system (1) also comprises a system, in which essentially only mobile devices (2)—and possibly one or several smartcards (6)—are used, which comprise a security element SE for securely keeping and/or transferring e-money (4)—and are thus considered to be secure mobile devices—as long as non-secure mobile devices (2, 2″), which do not include a security element SE for securely keeping and/or transferring e-money (4), can also be used in the system (1) to pay with e-money (4).

In the case of cashless payment, an imperative and final settlement of the payment transaction is attained by means of the system (1) according to the invention in all cases, in particular even if the device (2) as well as the terminal (5) are offline. An e-payment transaction with imperative settlement, hereinafter also referred to only as settlement, with final effect is created thereby

The system (1) comprises the secure payment with any e-money, i.e. with e-money (4). The system (1) thus also comprises the payment with the e-money (4*) according to the invention and/or used according to the invention.

In a preferred embodiment, the system (1) comprises the secure payment with any e-money (4), but without crypto currencies. In this embodiment, e-money (4) thus comprises in particular the e-money (4*) according to the invention and used according to the invention, as well as e-money in the form of country currencies, which is stored, for example, on prepaid cards.

In a particularly preferred embodiment, the e-money (4) preferably used in the system (1) according to the invention is the e-money (4*) according to the invention and/or used according to the invention.

The secure payment with electronic money (4) in the system (1) according to the invention and using the method according to the invention preferably takes place in a contactless manner, i.e. that a radio connection between the device (2) and/or the smartcard (6) with the terminal (5) is necessary.

With the system (1) according to the invention, the user transfers money via a loading station or bank account to the device (2) and/or the smartcard (6), where it is stored as e-money (4). Paper money, which is placed into a loading station, for example, and book money, which is transferred from a bank account to the device (2), is transferred by the operator of the loading station or by the financial institution, respectively, where the bank account is set up, to a pool account. The countervalue thereof is stored as e-money (4) on the device (2) or the smartcard (6). E-money (4) stored on the device (2) can possibly also be further transferred to a smartcard (6). The pool account typically has no knowledge of the e-money (4, 4*) accounts on the individual devices (2, 2″) and is not informed of the individual payment transactions. It additionally has no significance for performing a final settlement. The book or paper money on the pool account belongs to the operator of the loading station or to a financial institution, for example, but not to the owner of the device (2) and thus of the e-money (4, 4*). The pool account is also not relevant in response to a payment transaction.

If e-money (4) is now used to pay by means of device (2) and/or smartcard (6), the value of the purchased goods is subtracted from the e-money (4) on the device (2) or on the smartcard (6), respectively, and is credited to the terminal (5) or to the cash register attached or connected to the terminal (5), respectively, and thus to the seller. The information relating to this transfer, i.e. to the payment transaction, is transmitted to the server (7), which can subsequently arrange for the amount credited to the seller at the cash register to be transferred from the pool account to the bank account of the seller, for example as book money. In addition, the corresponding amount, for example, is subtracted from the e-money (4) at the terminal (5) or is destroyed, respectively, i.e. deleted. E-money (4) is converted into money, in particular into book money, again by means of these steps.

The terminal (5) does not need to have a direct connection to the server (7), the terminal (5) in particular also does not need to be directly connected to the server (7) at the time of a payment transaction, regardless of whether or not it is connected to a cash register, and can thus be offline. Due to the fact that the terminal (5), however, can communicate with the device (2), for example by means of short-distance radio connection, such as NFC, and the device (2) can communicate with the server (7), in turn, by means of data network connection, the information relating to this transfer is transferred from the terminal (5) via the device (2) to the server (7). If neither the terminal (5) nor the device (2) are now connected to the server at the time and/or at the location of the payment transaction, i.e. if the terminal (5) as well as the device (2) are offline, the information relating to the payment transaction can be transferred from the terminal (5), for example by means of NFC, to the device (2), but not from the device (2) to the server (7) and also not from the terminal (5) to the server (7). This information, however, can be transferred from the device (2) to the server (7) at a later time, i.e. when the device (2) can establish a connection to the server (7) again.

The e-money (4*) according to the invention and the e-money (4), which is preferably present as e-money (4*) in the system (1) according to the invention, does not only comprise one type of token, but at least one load token TL (41) and, no later than after a first transaction, also at least one spend token TS (42), which differs from the load token TL (41).

In another particularly preferred embodiment of the system (1) according to the invention, the terminal (5) comprises at least one security element SEALS-SE (3), wherein the security element SEALS-SE (3) is suitable for keeping and transferring e-money (4, 4*) with final settlement even using a device (2) without security element SE and without Internet connection at the time of the payment transaction, wherein the terminal (5) and the device (2) do not need to be connected to the server (7) and can thus be offline at the time of a payment transaction for a final settlement of the payment transaction.

In a further particularly preferred embodiment of the system (1) according to the invention, the e-money (4) is present as e-money (4*), wherein the e-money (4*) comprises at least one load token TL (41) and, no later than after a first transaction, also at least one spend token TS (42), which differs from the load token TL (41). In addition, the terminal (5) comprises at least one security element SEALS-SE (3), wherein the terminal (5) and the device (2) do not need to be connected to the server (7) and can thus be offline at the time of a payment transaction for a final settlement of the payment process.

In a preferred embodiment, the device (2) and the terminal (5) and possibly the smartcard (6) and the terminal (5) communicate with one another by means of i) short-distance radio connection, such as, for example, RFID, NFC, Bluetooth, Bluetooth Low Energy (BLE) and/or Wi-Fi, ii) contact-based connection, such as, for example, USB and/or Firewire, iii) optical connection, such as, for example, IR, IRDA and/or NIR, iv) acoustic connection and/or v) data networks, such as, for example, TCP/IP.

In a further preferred embodiment, the device (2) and the server (7) communicate with one another by means of a data network connection, in particular by means of a radio data connection and/or a TCP/IP connection.

In another preferred embodiment, the terminal (5) and the server (7) need to have neither a direct nor an indirect data network connection with one another, for example via a device (2, 2″), at the time and at the location of the payment transaction.
The Device (2), (2′) and the Devices (2″)

The device (2) of the system (1) according to the invention and of the method according to the invention is a mobile device (2) with or without security element SE for securely keeping and/or transferring e-money. As mobile device, the device (2) is a portable device, which is also operational without fixed connection to an installation. The device (2) possibly comprises software, i.e. for example an application, with which the e-money (4) stored on the device (2) is managed.

Non-secure devices (2), (2″) are devices (2), which do not have a security element SE for securely keeping and/or transferring e-money (4) and which are approved for use by third parties, i.e. non-secure devices (2), (2″) do not comprise a security element SE or a type 1 security element SE, which allows only to store the cryptographic key and private data, for example information relating to the credit card, and which can be used to protect the stored money against theft, e.g. by means of malicious software (see also Table D). A non-secure mobile device (2) is thus a mobile device, in which private data and software are neither kept securely nor are protected against hacking, because the non-secure device (2) does not comprise suitable and/or available hardware.

According to the invention, newer generation mobile telephones, into which a security element SE is installed for securely storing, for example, credit card data, are considered to be non-secure devices (2), (2″). Such security elements SE are generally type 1 security elements and can thus not be used for secure cashless payment with e-money (4).

According to the invention, the term device (2) also comprises a device (2′), which is enhanced with a security element SEALS-SE (3) and possibly with software. With this expansion, the device (2′) forms a terminal (5). The device (2′) is thus considered to be a secure device (2).

The plurality of devices (2″) comprises a plurality of different devices (2), which typically belong to different users, who do not need to have any contact with one another.

Suitable devices (2, 2′, 2″) are commercially available and are known to the person of skill in the art. Non-limiting examples of preferred devices (2, 2′, 2″), which are often also considered to be non-secure devices, comprise mobile telephone, smartphone, tablet, notebook, laptop and/or smart wearables, also only called wearables. The device (2), however, can also be a special, typically non-secure mobile device, which is provided, for example, specifically for the system (1) and which thus determines the purpose of the secure, cashless payment.

In a preferred embodiment, the device (2) comprises at least
a processor,
a memory,
a power supply,
possibly a display and/or input field,
a mobile radio transceiver, WLAN transceiver and/or another sending/receiving unit for making contact with the server (7), as well as
a connection for the data transfer between the device (2) and the terminal (5), in particular a short-distance radio transceiver, a contact-based connection, an optical connection, an acoustic connection and/or a data network connection.

Suitable mobile radio transceivers for making contact with the server (7) are known to the person of skill in the art and are commercially available.

Suitable connections for the data transfer between the device (2) and the terminal (5) are known to the person of skill in the art. Non-limiting examples of suitable short-distance radio transceivers, also called near field radio transceivers, comprise Bluetooth, Bluetooth low energy (BLE), RFID, NFC, Wi-Fi and/or Wi-Fi Direct. Non-limiting examples of a suitable contact-based connection comprise connections by means of USB and/or Firewire. Non-limiting examples of a suitable optical connection comprise IR (infrared), IRDA (infrared industrial standard) and/or NIR (near infrared). Non-limiting examples of a suitable data network connection also comprise TCP/IP connections. Bluetooth, Bluetooth low energy (BLE), RFID, NFC, ZigBee, and/or Wi-Fi are preferred as data transfer between the device (2) and the terminal (5).
The Security Element SEALS-SE (3)

According to the invention, the term security element, i.e. security element SE, is understood to be a chip, which enables arbitrary operations, including cryptographic operations, in secure environment, and which comprises a secure key and data memory.

The security element SEALS-SE (3) used according to the invention is a type 3 security element SE (see Table D) comprising specific cryptographic abilities, which locally enable a final settlement of a payment transaction, even if the device (2) and the terminal (5) are offline. In addition, the security element SEALS-SE (3) is suitable for keeping and transferring e-money (4) with final settlement even with a device (2) without security element SE and without Internet connection at the time of the payment transaction. The abbreviation SEALS-SE stands for Secure E-money Accounting & Local Settlement—Secure Element.

TABLE D
Definition of the type 1, type 2, and type 3 security
elements SE. The type 3 security element corresponds
to the security element SEALS-SE (3).

| | Cryptographic | | |
|---|---|---|---|
| | operations in | | |
| | secure environment | | |
| Security | possible & secure | | Accounting/ |
| element | key and data | Secure e-money | settlement |
| SE | memory available? | memory available? | possible? |
| no SE | no | No | no |
| type 1 ^{a)} | yes | No | no |
| type 2 ^{b)} | yes | Yes | no |
| type 3 ^{c)} | yes | Yes | yes |

a) A type 1 security element SE allows to securely store the cryptographic key and data, such as, for example, information relating to the credit card.

b) In addition to the storing of the cryptographic key and data, a type 2 security element SE additionally allows to securely store e-money (4).

c) In addition to the abilities of a type 2 security element SE, a type 3 security element SE also allows to keep e-money (4) in a means of payment without security element SE, i.e. device (2), and to transfer e-money (4) from a means of payment without security element SE, for example device (2), to a terminal, i.e. terminal (5), wherein only the terminal (5) imperatively requires a type 3 security element SE. The security element SEALS-SE is a security element SE suitable for this purpose. In addition, the type 3 security element allows the settlement of the payment transaction, even if the means of payment, e.g. the device (2), and the terminal (5) are offline.

The security element SEALS-SE (3), hereinafter also only called security element (3), SEALS-SE (3) or security element SEALS-SE, is suitable for securely keeping, i.e. storing, e-money (4) as well as for securely transferring e-money (4) from one device to another device with final settlement, wherein no Internet connection is necessary for the final settlement at the time of the payment transaction with the security element SEALS-SE (3). If a device, for example a terminal (5), has such a security element SEALS-SE (3), the other device can—due to the abilities of the security element SEALS-SE (3)—be a non-secure device (2) without specific security functions.

The security element SEALS-SE (3) is thus in particular suitable for securely keeping e-money (4) on a device (2) and securely transferring e-money (4), in particular for offline payments with e-money (4, 4*) from a device (2) at a terminal (5) and/or from a smartcard (6) at a terminal (5). This payment transaction can generally also take place in a contactless manner.

In addition, the security element SEALS-SE (3) of the system (1) according to the invention is a registered security element SE, which cannot be counterfeited and which is qualified to the effect that an e-money payment transaction with imperative settlement with final effect can be performed with it, without the additional authorization by a central server, and thus offline. In the system (1) according to the invention, the security element SEALS-SE (3) is responsible for security-relevant tasks in the case of transactions between device (2) and terminal (5) and between smartcard (6) and terminal (5). The security element SEALS-SE (3) protects the e-money (4, 4*) against misuse, unwanted external influence and/or manipulation. The security element SEALS-SE (3) can be based on a conventional security element SE, which is processed, for example with a special software, into a SEALS-SE (3). The person of skill in the art can produce such security elements SEALS-SE (3) by means of suitable software, for example.

The security element SEALS-SE (3) thus differs from a conventional, commercially available security element SE in such a way that a security element SEALS-SE (3) is designed for the e-money transfer from a device (2) to a terminal (5) and/or vice versa, wherein only the terminal (5) needs to be embodied with a corresponding SEALS-SE and not the device (2), and the e-money is stored on the device (2)—without the protection by a local security element SEALS-SE—in the conventional non-secure data memory. The security element SEALS-SE (3) in the terminal (5) thereby also takes over the payment-preparatory task of the misuse and counterfeiting examination in addition to the settlement. The security element SEALS-SE (3) can detect and prevent a double use of one and the same e-money (4)—to a very high degree, e.g. due to a system backup. The security element SEALS-SE (3) thus has significantly higher cryptographic properties than a conventional, commercially available type 1 or type 2 security element SE.

The security element SEALS-SE (3) thus represents a type 3 security element SE and, in addition to storing data, such as cryptographic keys, i.e. keys and information relating to the credit card (type 1) and storing e-money (type 2), additionally allows to transfer e-money (4) between means of payment, i.e. device (2) and terminal, i.e. terminal (5), wherein only the means of payment or the device imperatively requires such a security element SE.

The security element SEALS-SE (3) used according to the invention thus differs significantly from security elements SE, which are partially used in latest generation mobile telephones (type 1 security elements). This is so, because commercially available security elements SE are not suitable for secure offline payments with e-money (4) due to their characteristic, for example due to the software contained in the security elements.

The security-relevant tasks performed by the security element SEALS-SE (3) used according to the invention typically comprise authentication of the device (2), the representation of the server (7) in the terminal (5), for example by verifying and/or signing the spend and load tokens, as well as detecting certain fraud attempts at the terminal, such as, for example, double or multiple payment with only one settlement. In addition, the security element SEALS-SE (3) can advantageously generate and verify signatures, buffer the load tokens TL (41) and/or spend tokens TS (42), generate new e-money tokens (41, 42), as well as prevent certain manipulation and fraud attempts. The security element SEALS-SE (3) also monitors, which amount is transferred from the device (2) to the terminal (5). The SEALS-SE (3) further provides tools for the telegram encryption.

The security element SEALS-SE (3) cannot change the received e-money (4, 4*) in the terminal (5) without the involvement of e-money (4, 4*) of a device (2, 2″). The security element SEALS-SE (3) also appears as referee in the system (1), represents the interests of the system (1), provides protection against fraud, and protects the integrity of the system (1).

In a highly preferred embodiment of the system (1), the security element SEALS-SE (3) is used in every terminal (5). Payment transactions can thus also be performed in the system (1) according to the invention with mobile devices (2, 2″) without security element, i.e. also with non-secure devices (2, 2″).

In another preferred embodiment, the security element SEALS-SE (3) represents a physical security element in the terminal (5) and advantageously comprises a processor with cryptographic suitability.
The Terminal (5)

According to the invention, terminal (5) is understood to be any point-of-sale (POS), in the case of which a payment transaction can be performed using a device (2, 2″) with e-money (4, 4*).

If the e-money (4*) according to the invention is used in the system (1) according to the invention, a payment transaction can be performed at a terminal (5) with or without security element SEALS-SE. For an increased security of the system (1), however, it is generally advantageous when the payment transaction with e-money (4*) is performed at a terminal (5) with a security element SEALS-SE. A secure payment transaction can thus be performed at a terminal (5) offline and with final settlement even using a device (2, 2″) without security element.

If the system (1) according to the invention does not specifically use e-money (4*), but any e-money (4), the terminal (5) comprises a security element SEALS-SE according to the invention. A secure payment transaction can thus be performed at a terminal (5) offline and with final settlement even using a device (2, 2″) without security element.

The terminal (5), i.e. payment terminal (5), in the system (1) according to the invention performs the credit balance transactions from the device (2) to the terminal (5), provided that the device (2) gives the terminal (5) consent for doing so, and from the terminal (5) to the device (2), provided that the terminal (5) gives the device (2) consent for doing so. Consent is given, when the device (2) as well as the terminal (5) believe its counterpart has integrity, is authentic and cooperative. The terminal thus completes the tasks of the sales process, such as the transfer of an amount from the device to the terminal, start of the product dispensing or service—possibly after generating and transmitting an acknowledgement to the device (2), as well as possibly scattering the acknowledgements across a plurality of devices (2″) for transmission to the server (7). This scattering is preferably performed until at least one receipt confirmation, which confirms the receipt of the acknowledgement from the server (7), has arrived at the terminal (5).

The terminal (5) additionally stores undertaken transactions for settlement and control purposes, and sends the stored transactions as transaction telegrams via the device (2) and/or the plurality of the devices (2″) to the server (7). Suitable terminals (5) are commercially available and are known to the person of skill in the art.

The term terminal (5) preferably comprises a processor, a memory and/or software. The terminal is preferably operated via a user interface and/or is controlled via a machine interface. The terminal (5) is typically also part of a cash register or is connected to a cash register.

The terminal (5), i.e. the payment terminal (5), of the system (1) according to the invention and of the method according to the invention comprises at least one security element SEALS-SE (3). At the beginning of a payment transaction, the security element SEALS-SE (3) verifies whether the e-money (4, 4*) stored on the device (2) is trusted and consistent, i.e. error-free, and detects and prevents the locally detectable fraud attempts in that it recomputes at least the respective signatures of the most recent load tokens TL (41) and/or spend tokens TS (42) and searches for token duplicates, and thus double payments, so-called “double-spends”. After the payment transaction has taken place at the terminal (5), the security element SEALS-SE (3) typically confirms the validity of the load token TL (41) and/or of the spend token TS (42) in the terminal (5) by means of a signature, i.e. it provides the token with a complicated bit pattern, which is unambiguously associated therewith and the originality and authenticity of which can essentially be recognized and validated by everyone, but which only the security element SEALS-SE (3) itself and the server (7) can generate.

TABLE E
Influence of the security elements SE types in the means of payment and in the terminal (5)
on payment transactions with e-money (4). All listed means of payment allow the loading, i.e.
crediting, and the debiting of e-money (4), offline transaction times of under 5 seconds as
well as a final offline settlement with the corresponding security element in the terminal.

| | Security element | | | |
|---|---|---|---|---|
| | SE ^{b)} in | Security element | e-money ^{c)} | Shifting |
| Means of | the carrier of the | SE ^{b)} in | manageable on | of e-money |
| payment ^{a)} example | means of payment? | the terminal? | means of payment? | possible? |
| prepaid card | type 2 | type 1 | no | no ^{d)} |
| debit card | type 2 | type 2 | no | yes |
| non-secure device | no SE | type 3 | yes | yes |
| (2); according to | | | | |
| invention | | | | |

a) See Table A.

b) See Tables A, B, C, and D relating to type 1, 2, and 3 security element SE.

c) See Tables A, B, and C.

d) Due to the fact that the security element SE in the terminal (5) is a type 1 security element, which cannot store any e-money, no e-money can be shifted from the prepaid card to the terminal (5), i.e., only a devaluation of the prepaid card can be performed.

Table E clearly shows that no security element SE needs to be present solely in the means of payment of the present invention, i.e. in the device (2), and a final settlement of the payment transaction can nonetheless be attained. In addition, the transaction time in response to an offline payment remains maximally in the lower seconds range. According to the invention, this occurs essentially in that the terminal (5) is equipped with a type 3 security element SE, i.e. a security element SEALS-SE (3).

It is thus made possible in the terminal (5) by means of the security element SEALS-SE (3), which is used according to the invention and operated according to the invention that e-money (4) can be used for payment in particular even using a non-secure device (2) at a terminal (5), even if the device (2) as well as the terminal (5) have no connection to a secure server (7) and are thus offline at the time of a payment transaction.

According to the invention, the terminal (5) thus does not need to be connected to the server (7) at the time of a payment transaction and can be offline—even permanently.

The terminal (5) is a point-of-sale, in particular a vending machine, such as, for example, a beverage, coffee, coin, newspaper, snack, stamp, parking ticket and/or cigarette machine. Suitable terminals (5) are known to the person of skill in the art.

The terminal (5) can be connected to a cash register or the terminal (5) can be integrated into a cash register. Neither the terminal (5) nor the cash register need to be connected to the server (7) at any time—not even during a payment transaction. The terminal (5)—and the cash register, if available—thus do not need to have a telephone and/or Internet connection at any time and it can be permanently offline.

In a particularly preferred embodiment, the terminal (5) comprises a short distance radio transceiver, a contact-based connection, an optical connection, an acoustic connection and/or a data network connection for the data transfer between the device (2) and the terminal (5).

In a preferred embodiment, the terminal (5) comprises at least:
a processor,
a memory,
a power supply,
a user interface, in particular a touch display, and/or a machine interface, such as, for example, a USB connection,
a short distance radio transceiver, a contact-based connection, an optical connection, an acoustic connection and/or a data network connection for the data transfer between the device (2) and the terminal (5), as well as
the security element SEALS-SE (3).

In another preferred embodiment, the terminal (5) of the system (1) according to the invention is formed by a device (2′), wherein the device (2′) comprises a device (2), which is enhanced with a security element SEALS-SE (3) and possibly with software and/or hardware. The security element SEALS-SE (3) can thereby be fixedly integrated in the device (2′) and/or externally connected to the device (2′). This embodiment is advantageous in particular when a mobile multi-function terminal (5) is desired, which, for example, also has all advantages of a device (2′). Such a mobile terminal (5) comprising a device (2′) with security element SEALS-SE (3) can be extremely advantageous, for example, in the case of cashless road and/or beach sales.
The Smartcard (6)

The smartcard (6) of the system (1) according to the invention is optional and can be used by the user of the device (2) and/or by another user, who does not need to have a device (2), independently of a device (2). E-money (4), with which cashless and offline payments can be made, is stored on the smartcard (6).

Typically, the smartcard (6) is a conventional, commercially available prepaid card. It generally comprises a type 2 security element SE for securely keeping and/or transferring e-money, in order to ensure the necessary security against counterfeiting and misuse. Suitable smartcards (6) are known to the person of skill in the art.

According to the invention, the smartcard (6) is considered to be secure, if it has a type 2 or type 3 security element and is approved for use by third parties. The smartcard (6) used according to the invention thus comprises a type 2 or type 3 security element.
The E-money (4)

Electronic money, i.e. e-money, is also known under the names e-cash, computer money, digital money, and cyber money. In addition to the money from central banks, also called paper money, and the book money from the commercial banks, the e-money is a third, newer form of money.

The term e-money (4) comprises all types of e-money, in particular also the e-money (4*) according to the invention and used according to the invention.

If e-money (4, 4*) is transferred to a mobile device (2) in the system (1) according to the invention, the e-money (4, 4*) is stored on the prepaid card of the mobile device (2). In response to a payment transaction, the e-money (4, 4*) —or a portion there of—is transferred from the device (2) to the terminal (5). The owner of the e-money (4, 4*) is thus also the owner of the mobile device (2) or of the terminal (5), respectively. It is thus not necessary in the system (1) according to the invention that the user of the e-money (4, 4*) is registered in the pool account, in a register, or otherwise.

In a preferred embodiment, the term e-money (4) covers the e-money (4*) as well as e-money in the form of country currencies, which can be stored, for example, on prepaid cards, but not crypto currencies.

In a particularly preferred embodiment, the term e-money (4) covers the e-money according to the invention and/or used according to the invention.

The term e-money (4*) covers the e-money (4*) used according to the invention comprising at least one load token TL (41) and, after a first payment transaction, also at least one spend token TS (42), which differs from the load token TL, as well as the e-money (4*) according to the invention.

The e-money (4) is stored on the device (2) and possibly on the smartcard (6) and is preferably managed in a so-called electronic wallet, also called e-wallet or e-purse, by means of software. The e-money (4) can be stored in any currency. It is also possible to store e-money (4) in different currencies and to possibly pay with the corresponding currency.

In a particularly preferred embodiment, the e-money (4) used in the system (1) according to the invention and in the method according to the invention comprises e-money (4*) comprising at least two tokens, which differ from one another, namely a load token TL (41) and a spend token TS (42). The e-money (4*) can also comprise further tokens, wherein the further tokens can record and/or transmit other aspects of a transaction.

The e-money (4*) according to the invention for secure payment using the device (2), in particular for secure cashless payment using a non-secure device (2), at a terminal (5) according to the system (1) comprises at least one load token TL (41) and, after a first payment transaction, also at least one spend token TS (42), which differs from the load token TL (41). The load token TL (41) thereby differs from the spend token TS (42) not only in the content of the tokens, but the type of the information contained in the load token TL (41) differs significantly from the information contained in the spend token TS (42).

The load token TL (41) is stored on the device (2) and/or the smartcard (6) and comprises at least the amount of a credit and preferably also the value, which is current at the time this token is generated, of the e-money (4*) stored on the device (2) and/or the smartcard (6). In addition, the load token TL (41) preferably also comprises information relating to the device (2) or relating to the owner of the device (2), respectively.

The spend token TS (42), in contrast, comprises at least the value of the goods values of the goods purchased in response to a specific payment transaction and preferably further information relating to the respective payment transaction, such as, for example, date, remaining credit balance, product name and/or transaction counter, in particular relating to the device (2) and/or the smartcard (6) involved in the payment transaction, as well as the terminal (5) involved in the payment transaction, and thus represents a payment transaction with e-money (4*) from the device (2) to the terminal (5), wherein the spend token TS (42) is stored at least on the device (2) and/or terminal (5). If a payment transaction is processed at at least two different terminals (5) using one device (2), a separate spend token TS (42) is generated for each individual terminal (5) and each currency.

In addition, the current value of the e-money (4*) stored on the device (2) is represented by the sum of the load tokens TL (41) minus the sum of the spend tokens TS (42), wherein the at least one load token TL (41) and the possibly at least one spend token TS (42) preferably contains information, which allows a chronological arrangement. Such information can be, for example, a time stamp, a token index and/or a transaction counter.

In response to a payment transaction, the spend token TS (42) represents the value of the goods of the goods purchased/sold in response to a payment transaction, which is transferred as e-money (4*) in the form of the spend token TS (42) from the device (2) and/or the smartcard (6) to the terminal (5). The value of the goods represented in the spend token TS (42) is subtracted from the credit balance on the device (2) and/or the smartcard (6) and is simultaneously credited to the terminal (5), wherein the credit balance on the device (2) is represented by the difference of all load tokens TL (41) and spend tokens TS (42) stored on the device (2), and the credit balance in the terminal (5) is represented by the newly generated spend token TS (42).

In a preferred embodiment, the e-money (4*) stored on the device (2) after payment transactions at a plurality of terminals (5) has i) a load token (41) for each currency and ii) another spend token (42) for each terminal (5) and thus a plurality of spend tokens (42).

In one embodiment, the spend token TS (42) of the e-money (4*), which is preferably used in the system (1), and/or of the e-money (4*) according to the invention, is represented by a transfer token TT (421) and a termination token TR (422). The transfer token TT (421) represents a credit balance, i.e. a value of the goods, which was transferred from a device (2) to a terminal (5) and/or from a terminal (5) to a device (2). The termination token TR (422) represents a purchase, i.e. information relating to the purchased good or goods, with the transferred credit balance at the terminal (5). In this embodiment, the transfer of the credit balance to the seller is separated from the concrete purchase. Surprisingly, the robustness against connection interruptions between terminal (5) and device (2) is increased thereby. The corresponding transfer token TT (421) as well as the termination token TR (422), which together represent the spend token TS (42), are now required for the reconversion of e-money (4*) into book money. The term spends token TS (42) thus also covers the two terms transfer token TT (421) and termination token TR (422).

The at least one load token TL (41) of the e-money (4*) is stored on the device (2) and, together, all load tokens TL (41) of the e-money (4*) on the device (2) comprise the sum of the credits of the e-money (4*) of a currency stored on the device (2).

The possibly at least one spend token TS (42) of the e-money (4*) is stored on the device (2) and, together, all spend tokens TS (42) of the e-money (4*) on the device (2) comprise the sum of the payments of the e-money (4*) of a currency stored on the device (2).

In one embodiment of the e-money (4*), a load token TL (41) only comprises the information relating to a credit balance, and a spend token TS (42) only the information relating to a payment. The individual load tokens TL (41) and individual spend tokens TS (42) of the current and of earlier transactions are strung together to form different chains, wherein these chains can each serve different purposes:
One chain can comprise, for example, all load tokens TL (41) and spend tokens TS (42) of a single device (2) and can form a so-called value chain CV of the device (2), whereby the credit balance of a device (2) can be represented.
Another, second chain can, for example, form a so-called transfer chain CT from all spend tokens TS (42) of a single device (2) with a single, specific terminal (5). Such a transfer chain CT thus represents all e-money (4*), which was transferred from the device (2) to the specific terminal (5).
A further, third chain, can, for example, form a so-called POS chain CP from all spend tokens TS (42) of all devices (2, 2″) with a single terminal (5). Such a POS chain CP thus represents all e-money collected from the terminal (5).

In addition, further useful chains can also be formed with the load tokens TL (41) and/or spend tokens TS (42).

In another embodiment, a chain possibly includes at least one load token TL (41) and possibly at least one spend token TS (42). The sum of all credits of the load tokens TL (41) minus the sum of all payments of the spend tokens TS (42) forms the monetary nominal value of a chain. In response to a new credit or payment, respectively, the entire current chain is attached in highly compressed form to the new load token TL (41) or new spend token TS (42), respectively. The respective newest and thus most current token (41, 42) thus also comprises the history of all previous transactions as so-called hash. Such chains with compressed history are called hash chains.

In a preferred embodiment of the system (1) according to the invention and of the e-money (4*) according to the invention, a chain or a hash chain, comprising at least one load token TL (41) and, after a first payment transaction, also at least one spend token TS (42), which differs from the load token TL (41), is stored on the device (2) and possibly the smartcard (6) for each available currency. The history of the credits and debits in the respective currency is thus displayed by the order of the tokens.

Due to this arrangement, the load token TL (41) contains essentially the information relating to a credit to the e-money (4*), which is preferably stored on the device (2), as well as the history of the older load tokens TL (41) as hash, i.e. in highly compressed form. And a corresponding spend token TS (42) essentially contains only the information relating to the most current payment transaction between the device (2) and a specific terminal (5) or the smartcard (6), respectively, and a specific terminal (5), as well as the history of the older spend tokens TS (42) as hash, i.e. in highly compressed form. This leads to significant improvements, for example in the misuse detection and in the payment processing, a quicker transmission of the information to the device (2), the plurality of devices (2″), as well as to the server (7) and thus to the acceleration of the payment transactions.

In a preferred embodiment, the e-money (4*), which is preferably used according to the invention and/or the e-money (4*) according to the invention is based on a hash chain, wherein at least one hash chain is used comprising at least one load token TL (41) and possibly at least one spend token TS (42).

In a further preferred embodiment, the e-money (4*), which is preferably used according to the invention and/or the e-money (4*) according to the invention is based on at least two different hash chains. A first hash chain comprises at least one load token TL (41), possibly the older load tokens (41) as history, as well as possibly at least one spend token (42). A second hash chain comprises at least one spend token TS (42) of the first hash chain and possibly the older spend tokens (42) as history.

The division of the e-money (4*), which is preferably used in the system (1) according to the invention as well as of the e-money (4*) according to the invention and of the e-money (4*) used in the method according to the invention into at least two tokens (41, 42), which differ from one another, surprisingly has a plurality of advantages. Different chains and hash chains can thus be generated therewith. It is thus possible to perform transactions with extremely high security demands offline, which is not possible with today's systems using mobile—typically non-secure—devices alone. In addition, the number of the hash chain elements, i.e. tokens (41, 42), which is necessary for the traceability, is highly reduced, thus allowing for a much quicker processing. In other words: The storing, processing and/or transmitting can be performed with two types of hash chains, which are independent of one another, much more quickly than if all information is available on a single hash chain. The payment transaction is thus significantly accelerated and less memory is required. In addition, the system (1) becomes significantly less susceptible to errors, which, in turn, increases the security of the system (1).

A hash chain, by means of which the value of the e-money (4*) is represented, can also be securely stored on a non-secure device, i.e. for example on the device (2), even though the device (2) does not have a security element, which protects the e-money (4*) against unwanted manipulations. This is supported inter alia when individual load tokens TL (41) and/or spend tokens TS (42) of the chain or hash chain, respectively, stored in the device (2) are also available in other chains or hash chains, respectively. A manipulation is thus generally already detected in response to the payment attempt and on the server at the latest, and is corrected immediately, for example by additional charging and/or in that the device, on which a manipulation was detected, is blocked in the system (1).
The Server (7)

The system (1) according to the invention comprises one or several servers (7). The server (7) is typically connected to the devices (2, 2″) by means of an unsteady and highly asynchronous connection. According to the system (1), the server (7) does not need to directly communicate with the terminal (5), but only indirectly via the devices (2, 2″). In addition, the server (7) is not necessary for offline payment transaction with final settlement, i.e. it does not validate a payment transaction and thus does not participate in the final settlement of a payment transaction.

The server (7) used according to the invention in the system (1) is typically a central server (7), which is arranged, for example, in the Internet, the cloud and/or on company premises. Suitable servers (7) are commercially available and are known to the person of skill in the art.

The server (7) is responsible for monitoring and controlling the payments made in response to the payment transactions, can detect inconsistencies, counterfeiting and misuse with e-money (4) in the system (1), and can possibly take corrective measures. If necessary, the server (7) can even lift the pseudonymity of a user and can initiate legal action. The server (7) is thus a routing, protocol and monitoring server and is not responsible for performing individual online and/or offline transactions, including the final settlements thereof. In other words: Payment transactions can be performed offline and with final settlement in the system (1) even without server (7). The server (7) detects and prevents a potential misuse of the system (1), provides the owner of the terminal (5) and the operator of the system (1) access to a transaction journal and makes it possible for the owner of the terminal (5) and for the operator of the system (1) to correctly exchange e-money (4, 4*) into book or paper money.

In addition, the server (7) receives, stores and processes the telegrams, such as spend telegrams or acknowledgments, respectively, received from the device (2, 2″), and sends telegrams, such as receipt confirmations, alarm information, lock notifications, etc., to the devices (2, 2′, 2″) and via the devices (2, 2″) to the terminals (5). It can additionally generate e-money (4) and possibly associated signatures and/or certificates, issue validity certificates for the devices (2, 2′, 2″), administers the wallets located on the devices (2, 2′, 2″) and the smartcard (6), and verifies the consistency thereof, the server (7) possibly also initiates the balancing of a payment transaction or of a collection of payment transactions with money transfer to the seller's bank account.

The server (7) is typically a trusted server. The person of skill in the art knows the criteria for awarding a server with the title “trusted server”. A trusted server thus typically comprises an entire catalog of measures, which make it trusted, such as, for example, the location and the physical security positive of the server, the available firewalls, monitoring circuits, redundancy, trusted/secure elements, as well as the data diffusion. The system (1) can thus trust that the operations of the server (7) are performed correctly and as defined by the system (1) and that these operations are not manipulated, falsified or influenced otherwise to the disadvantage of the system (1) by the influence of third parties.
The Method

The method according to the invention for secure payment with e-money (4, 4*) using the device (2) with the system (1) according to the invention, i.e. using the system (1) according to the invention, comprises at least one of the below-mentioned steps a) to d). When the method comprises two or more of the following steps, the steps can be performed in any order and/or can be performed or combined simultaneously, respectively.

Step a) of the method according to the invention comprises the storing of e-money (4*), which is preferably used in the system (1), on the device (2) and/or a terminal (5), wherein the preferably used e-money (4*) comprises at least one load token TL (41) and, after a first transaction, also at least one spend token TS (42). Different authorizations can thus be granted for load tokens TL (41) and for spend tokens TS (42), whereby secure offline payments can be made.

Step b) of the method according to the invention comprises a payment transaction with imperative, i.e. final settlement, with e-money (4, 4*) comprising a transaction, i.e. transfer, of a credit balance from the device (2) to the terminal (5) and/or from the terminal (5) to the device (2), wherein the terminal (5) comprises at least one physical security element SEALS-SE (3), and the device (2) and the terminal (5) communicate with one another, i.e. the device (2) and the terminal (5) have a permanent, time-limited established connection during the transaction. The transaction of the credit balance is thereby preferably represented in at least one spend token TS (42). Due to the security element SEALS-SE (3) in the terminal (5), the e-money (4, 4*) is signed by the device (2) and/or the smartcard (6), in particular the spend token TS (42). An imperative and final settlement and thus a secure payment transaction with e-money (4, 4*) is thus made possible between device (2) and/or smartcard (6) and terminal (5), even if the device (2), the smartcard (6), and the terminal (5) are open at the time of the payment transaction.

According to the invention, the term “final settlement of a payment transaction” is understood such that the credit standing of the buyer is satisfactory, the payment transaction is legally valid and has been completed, and thus has a final effect. Such a final settlement is unlike a temporary, i.e. not yet definitive, settlement, as it is the case, for example, in response to payment via credit card without Internet connection.

Step c) of the method according to the invention comprises the exchange of at least one telegram, i.e. notification, message, or information, respectively, between terminal (5) and server (7) and/or between server (7) and terminal (5), wherein the exchange of the at least one telegram takes place via the device (2) and/or a plurality of devices (2″). According to the invention, the term exchange is thereby understood to be transmission with receipt confirmation.

The exchange of the at least one telegram between terminal (5) and device (2, 2″) preferably takes place at the time of a payment transaction, and the exchange between device (2, 2″) and server (7) can take place at a different time. At the time of a payment transaction, the device (2) can thus of online or offline. It is also possible to pay by means of smartcard (6) at the terminal (5), wherein the telegram assigned to the payment transaction by means of smartcard (6) is exchanged with the server (7) at a later time via a device (2, 2″).

Step c) comprises different specific embodiments i) to iv), which can possibly also be performed in combination with one another and which will be described in more detail below.

If the device (2) is connected to the server (7) at the time of a payment transaction in one embodiment i) and is thus online, the terminal (5) exchanges at least one telegram of the payment transaction with the server (7) via the device (2). At least one telegram is thereby advantageously transmitted from the terminal (5) to the server (7) via the device (2). The server (7) subsequently sends a telegram with the receipt confirmation via the device (2) to the terminal (5). Due to the receipt of the receipt confirmation, it is confirmed to the terminal (5) that the payment transaction occurred correctly and that the corresponding amount of money will be transferred to the seller's bank account. The payment transaction can accordingly be balanced, for example, with step e) of the method according to the invention.

If the device (2) is not connected to the server (7) at the time of a payment transaction in a further embodiment ii) and is thus offline, the terminal (5) transfers at least one telegram, preferably all telegrams generated in response to the payment transaction, of the payment transaction to the device (2). Due to the fact that the device (2) is offline, it cannot transfer the at least one telegram to the server (7) and can accordingly also not receive a telegram with a receipt confirmation and transmit it back to the terminal (5). As long as a telegram with the receipt confirmation for the telegram of the current payment has not yet been received by the server (7) at the terminal (5), the terminal (5) transmits the at least one telegram to a plurality of further devices (2″) in response to subsequent payment transactions. The device (2) and each of the devices (2″) then send the at least one telegram to the server (7) at least once, until the at least one telegram is transmitted to the server (7), and the server (7) transmits a telegram with the receipt confirmation to the terminal (5) via at least one device (2, 2″). A payment transaction is thus allowed offline in a simple manner, without the device (2) and the terminal (5) having to have an online connection to the server (7) at the time of the payment transaction.

If the device (2) is connected to the server (7) independently of a payment transaction in another embodiment iii) and is thus offline, the server (7) can transmit pending telegrams, in particular pending telegrams relating to at least one payment transaction, using the same device (2) and/or using another device (2″), i.e. using at least one of the plurality of devices (2″), to at least one terminal (5), to the device (2), which later transmits it to the terminal (5). This approach surprisingly allows in a simple manner that a user can make a payment only one time using a device (2) at the terminal (5), even offline, or needs to be present, respectively, and the acknowledgement is nonetheless confirmed by the server (7) to the terminal (5).

The approaches for transmitting telegrams from a terminal (5) via a plurality of devices (2, 2″) to the server (7) and/or from the server (7) via a plurality of other devices (2, 2″) to the same terminal (5) as mentioned in the embodiments ii) and iii) of method step c) is called swarm communication according to the invention. In response to an offline payment transaction, the possible money carryover from the pool account to the seller's cash account is ensured even in response to an offline payment transaction, for example by means of subsequent step e) of the method according to the invention, wherein the money carryover is prompted by the server (7).

The fact that, as mentioned in embodiments ii) and iii) of method step c), the device (2) as well as the terminal (5) are offline at the time of the payment transaction, is not uncommon even in highly industrialized areas. Non-limiting examples comprise vending in basements, events in recreation areas with mobile hole and brief unavailability of the Internet and/or server (7). It is considered to be extremely likely, however, that at least the device (2) and/or one of the plurality of devices (2″) establishes a connection to the server (7) again within a few hours or no later than after a few days, whereby the at least one telegram can be transmitted from the terminal (5) to the server (7). Virtually simultaneously, i.e. briefly offset in time, the device (2) and/or at least one of the plurality of devices (2″) receives a telegram with the receipt confirmation. After receipt, this telegram is transferred from the device or the devices (2, 2″) to the terminal (5). The plurality of devices (2″), which receive the at least one telegram from the terminal (5) and typically transfer it to the server (7) with delay, can thereby be identical to or differ from the plurality of devices (2″), which receive the telegram with the receipt confirmation from the server (7). Simulations thereby showed that—with regard to the terminals—the number of devices (2, 2″) and the number of payment transactions per device (2, 2″) can be surprisingly low in order to ensure the operability of the system (1) according to the invention and of the method according to the invention.

If the payment transaction at the terminal (5) is performed by means of a smartcard (6) in an additional embodiment iv), the payment transaction is offline, because the smartcard (6) cannot communicate with the server (7). After completion of the payment transaction with the smartcard (6), the terminal (5) transmits at least one telegraph of the payment transaction with the smartcard (6) to the at least one device (2, 2″) in response to at least one subsequent payment transaction using at least one device (2, 2″). This transmission to at least one device (2, 2″) takes until a telegram with the receipt confirmation has been received at the terminal (5) by the server (7).

In other words: If a further payment transaction is performed after a payment transaction with smartcard (6) using a device (2), the terminal (5) does not only transmit the telegram of the payment transaction from the device (2) with the terminal (5), but also the telegram of the earlier payment transaction from the smartcard (6) with the terminal (5), to the device (2).

If the device (2) is now online—analogously to embodiment i)—the device (2) does not only transmit the telegram of the payment transaction from the device (2) with the terminal (5), but also the telegram of the earlier payment transaction with the smartcard (6), to the server (7). The server (7), in turn, transmits the telegram with the receipt confirmation of the payment transaction from the device (2) with the terminal (5), as well as the telegram with the receipt confirmation of the payment transaction from the smartcard (6) with the terminal (5) to the device (2). The device (2), in turn, transmits both telegrams to the terminal (5), for confirmation of both payment transactions. In the case of good connections, these transactions only take fractions of seconds or maximally a few seconds.

If the device (2) is offline, however—analogously to embodiment ii)—the terminal (5) does not receive a telegram with the receipt confirmation of the payment transaction in response to the subsequent payment transaction using the device (2). The terminal (5) thus transmits the telegram of the current payment transaction from the device (2″) with the terminal (5), as well as the telegrams of the earlier payment transactions from the smartcard (6) with the terminal (5), from the device (2) with the terminal and possibly from other devices (2″) with the terminal (5), to at least one further device, typically to a plurality of further devices (2″). The devices (2, 2″), in turn, transmit the telegrams at least once to the server (7). The server (7) typically acknowledges the receipt of the telegram immediately in that the server (7) sends a receipt information back to the respective device (2, 2″). As soon as a device (2, 2″) with a receipt confirmation contacts the terminal (5) again, this receipt confirmation is transmitted from the device (2, 2″) to the terminal (5), and the terminal (5) stops the transmission of telegrams to further devices (2, 2″). Due to this approach, the terminal (5) can possibly receive a plurality of receipt confirmations relating to the same payment transaction, wherein only the first received receipt confirmation is relevant.

Step d) of the method according to the invention comprises the monitoring and detection of misuse in the system (1) with e-money (4, 4*), wherein
the server (7) stores, processes the telegrams received by the devices (2, 2″), possibly blocks at least one device (2, 2″) for the system (1), and transmits other telegrams via the devices (2, 2″) to the terminal (5), and/or
the terminal (5) verifies at least the spend tokens TS (42) received from the devices (2, 2″) using the security element SEALS-SE (3) with regard to the correctness thereof, possibly blocks at least one device (2, 2″) for the system (1), and transmits at least one telegram via the devices (2, 2″) to the server (7).

This is so, because if telegrams received by the server (7), for example, which originate from a device (2, 2″), have irregularities, the server can block the device (2, 2″), in that it sends corresponding telegrams to the devices (2, 2″). They transfer the telegrams to at least one, preferably to a plurality of, in particular to all terminal, terminals (5). The terminals (5) thus recognize a blocked device (2). The server (7) can also analogously transmit other telegrams, for example with control information, to the terminal (5) via the devices (2, 2″). This further increases the security standard of the system (1) and acts in a preventive manner against misuse and counterfeiting.

Step e) of the method according to the invention is optional and typically takes place following at least one of the above-mentioned steps a) to d), wherein step e) comprises the buyback of the e-money (4, 4*) accumulated at the terminal (5) with money transfer to the seller's bank account, and thus the conversion of e-money (4, 4*) into physical money.

In the case of the method for secure cashless payment with the electronic money (4*) according to the invention using a device (2) at a terminal (5), the e-money (4*) comprises at least one load token TL (41) and, after a payment transaction, also at least one spend token TS (42), which differs from the load token TL (41).

The at least one load token TL (41) of the e-money (4*) is stored on the device (2) and, together, all load tokens TL (41) of the e-money (4*) on the device (2) comprise the sum of the credits of the e-money (4*) stored on the device (2).

The possibly at least one spend token TS (42) comprises at least the value of the goods of the goods purchased/sold in response to the payment transaction and possibly further information relating to the payment transaction, in particular relating to the device (2) and terminal (5) involved in the payment transaction. It thus represents a payment transaction with e-money (4*) from the device (2) to the terminal (5), wherein the spend token TS (42) is stored at least on the device (2) and/or terminal (5).

In addition, the current value of the e-money (4*) stored on the device (2) is represented by the sum of the load tokens TL (41) minus the sum of the spend tokens TS (42), wherein the at least one load token TL (41) and the possibly at least one spend token TS (42) preferably contains information, which allows a chronological arrangement. Such information is, for example, a time stamp, a token index and/or a transaction counter.

In the case of the method according to the invention for secure payment with e-money (4*) using a device (2) and possibly the smartcard (6), the e-money (4*) stores at least one load token TL (41) and, after a first payment transaction, also at least one spend token TS (42), which differs from the load token TL (41), for each available currency, wherein the at least one load token TL (41) and the at least one spend token TS (42) are preferably strung together chronologically with regard to the credits and debits in the respective currency and are preferably linked to one another as a hash chain.

Non-limiting, preferred embodiments of the system (1) according to the invention for secure payment with e-money (4), the e-money (4*) according to the invention and the method for secure payment with e-money (4) using a device (2) with the system (1) or the e-money (4), respectively, will be described below on the basis of the following drawings. They are not to be interpreted in a limiting manner and are understood as part of the description:

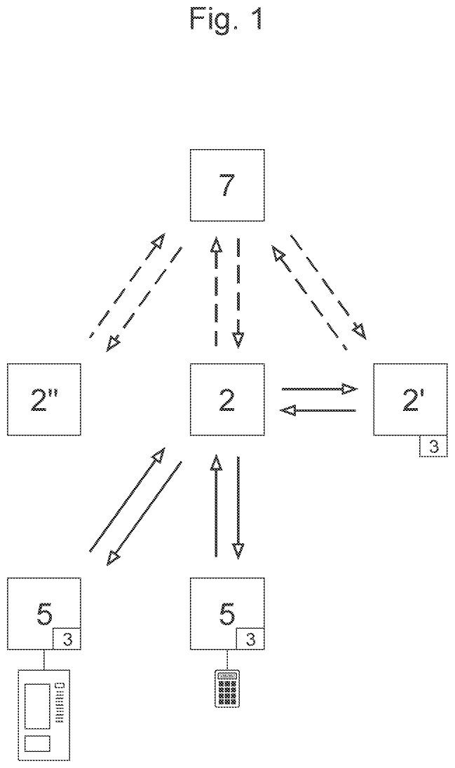

FIG. 1 shows, in an exemplary manner, a server (7), two different types of terminals (5), both of which have a security element SEALS-SE (3) for offline payments with e-money from a device (2) and/or a smartcard (6), and represent a vending machine or a terminal (5), respectively, at a cash register, as well as the devices (2), (2′) and (2″). The devices (2, 2′, 2″) are connected to the server (7), preferably via a typically unsteady data network connection. The unsteadiness of the data network connection is illustrated with interrupted arrows. The device (2), also representative for the plurality of the devices (2″), is connected to the terminals (5), for example via a short-distance radio connection, such as NFC, wherein the device (2′), which is enhanced with a security element SEALS-SE (3), also represents a terminal (5).

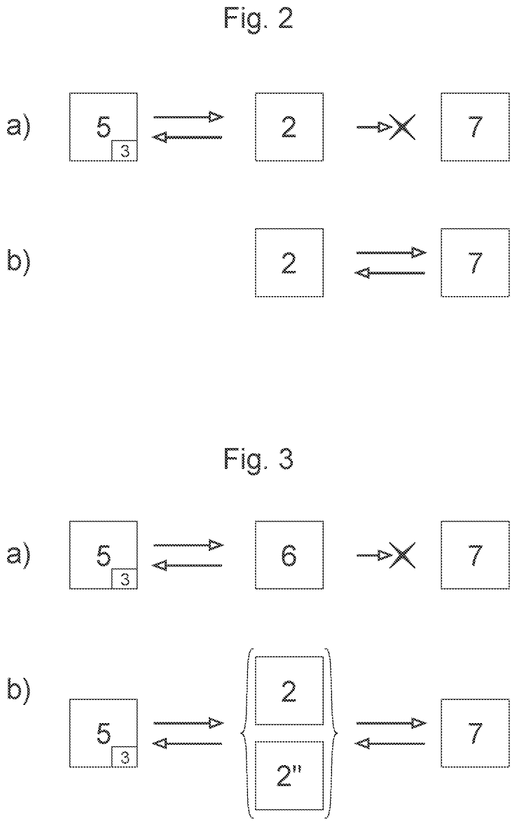

FIG. 2 shows, in an exemplary manner that a) a device (2) with the terminal (5) can process a payment transaction with final settlement offline, i.e. without connection to the sever. If the device (2) is online again later, i.e. connected to the server (7), b) the information necessary for a possible buyback of the e-money (4, 4*) accumulated at the terminal (5) as well as well as for monitoring the system, i.e. for detecting possible irregularities, such as manipulation or counterfeiting on the e-money (4, 4*), is transmitted to the server (7) in the form of at least one telegram. The server acknowledges the receipt of the telegram in the form of a receipt confirmation.

FIG. 3 shows, in an exemplary manner, a) an offline payment transaction with final settlement at the terminal (5) with a smartcard (6), which cannot establish a connection to the server (7) and is thus permanently offline, wherein no device (2) is necessary for the payment transaction with the smartcard (6). In response to a next contact of the terminal (5) using a device (2, 2″), which is online at the time of the contact, for example in response to a payment transaction, b) the information necessary for the completion of the payment transaction, i.e. for a possible buyback of the e-money (4, 4*) accumulated at the terminal (5) as well as well as for monitoring the system, is transmitted to the server (7) in the form of at least one telegram. The server acknowledges the receipt of the telegram in the form of a receipt confirmation, which the server (7) sends back to the terminal (5) via the device (2, 2″).

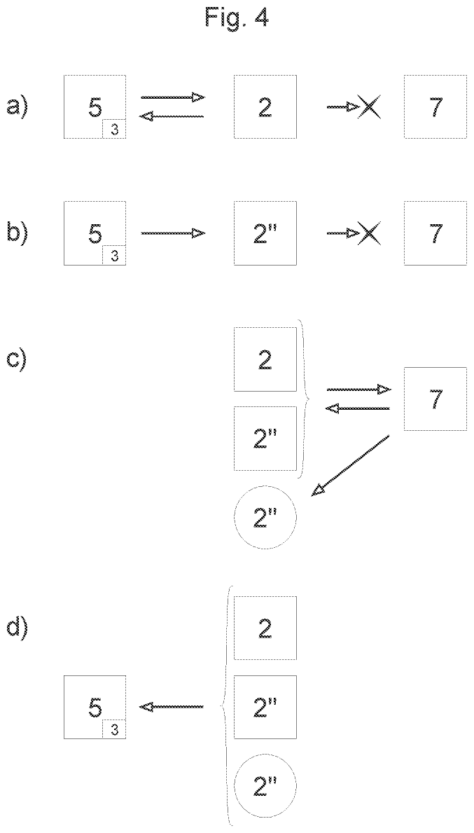

FIG. 4 shows, in an exemplary manner, an offline payment transaction at the terminal (5) using a device (2), which a) is offline, because the terminal and the device (2), for example, are in a dead spot or in a basement without Internet connection. Even though neither the terminal (5) nor the device (2) are online, a final settlement is performed with the system (1) according to the invention. In response to a next contact at the terminal (5) using a plurality of devices (2″), which are thus also offline at the time of the contact, b) the information necessary for a buyback of the e-money (4, 4*) accumulated at the terminal (5) is transmitted to the plurality of devices (2″) as acknowledgement in the form of at least one telegram. As soon as c) the device (2) and/or at least one of the devices (2″) are now online again, these telegrams are transferred to the server (7). The server confirms the receipt of all acknowledgement telegrams in that it sends a corresponding receipt confirmation to all devices (2, 2″), from which it has received the telegrams (illustrated as a square).

The server (7) preferably additionally also sends this receipt confirmation to further devices (2″), which have not received any corresponding telegrams from the terminal (5) (illustrated in round form), because such a device (2″) possibly establishes a contact with the terminal (5) sooner. As soon as d) a device (2, 2″) now contacts the terminal (5) with the receipt confirmation of an acknowledgement of an earlier payment transaction, the receipt confirmation of the server (7) is transmitted to the terminal (5) and the payment transaction on the side of the terminal (5) is identified as being acknowledged.

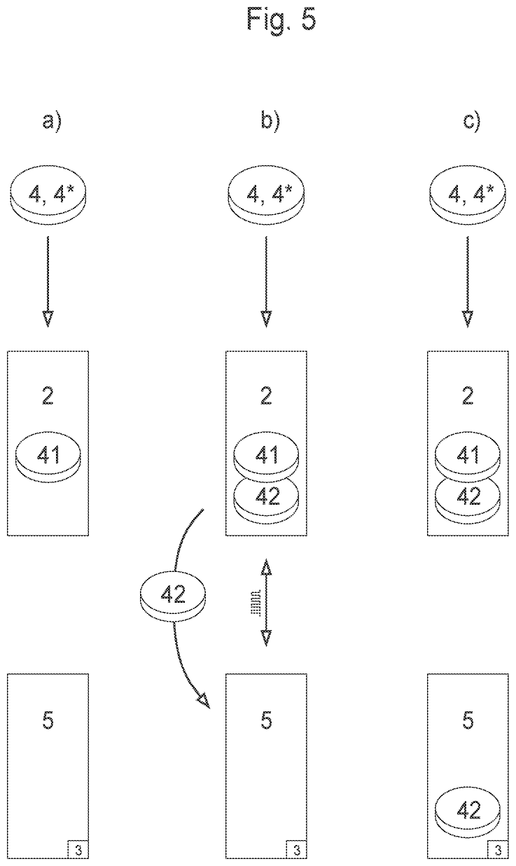

FIG. 5 shows, in an exemplary manner, e-money (4, 4*) according to the invention and preferably used according to the invention, which is stored on a device (2) and comprises at least one load token TL (41) and, after a first payment transaction, also at least one spend token TS (42), which differs from the load token TL, wherein

a) shows the load token TL (41), which comprises at least one credit of the e-money (4, 4*) stored on the device (2),

b) the spend token TS (42) is generated by the device (2) in response to a payment transaction using the device (2) at the terminal (5), which comprises a security element SEALS-SE (3), and a copy of the spend token TS (42) is transferred to the terminal (5). The spend token TS (42) comprises at least the value of the goods of the goods purchased/sold in response to the payment transaction, as well as information relating to the buyer and seller. The spend token (42) thus represents a payment transaction with e-money (4, 4*) from the device (2) to the terminal (5). The arrow with symbol between device (2) and terminal (5) represents an established connection with bidirectional data exchange and is thus a physical connection with signal transfer. The connection can occur, for example, by means of NFC.

c) After settlement has taken place, the spend token TS (42) is stored at least on the device (2) and/or the terminal (5). The value of the goods is thus deducted from the e-money (4, 4*) stored on the device (2) and is credited to the terminal (5) or the cash register associated therewith, respectively. Due to the fact that the spend token TS (42) is stored on the device (2) as well as on the terminal (5), a possible and erroneous money slippage is impossible. The performed payment transaction can thus also be traced retroactively without any problems, and a possible erroneous accounting transaction can be corrected.

1. A system (1) for secure a payment with an electronic money (e-money) (4), comprising:
at least one mobile device (2) with the e-money (4), wherein the e-money (4) is managed by a software,
at least one smartcard (6) with the e-money (4), wherein the e-money (4) is kept on the smartcard (6),
at least one payment terminal (5), and
at least one server (7),
wherein the e-money (4*) comprises at least one load token TL (41) and, after a first payment transaction, also at least one spend token TS (42), which differs from the load token TL, and/or
wherein the payment terminal (5) comprises at least one security element SEALS-SE (3), wherein the security element SEALS-SE (3) is suitable for keeping and transferring the e-money (4, 4*) with final settlement even using the least one mobile device (2) without the at least security element SEALS-SE and without internet connection at the time of the payment transaction, and the at least one payment terminal (5) and the at least one mobile device (2) do not need to be connected to the at least one server (7) for a final settlement at the time of a payment transaction and thus be offline.

2. The system (1) according to claim 1, wherein in that the at least one mobile device (2) and the at least one payment terminal (5) and the smartcard (6) and the at least one payment terminal (5) communicate with one another by i) a short-distance radio connection, such as, RFID, NFC, Bluetooth, Bluetooth Low Energy (BLE) and/or Wi-Fi; ii) contact-based connection, such as, USB and/or Firewire; iii) optical connection, such as, IR, IRDA and/or NIR; iv) acoustic connection; and/or v) data networks, such as TCP/IP.

3. The system (1) according to claim 1 wherein the at least one mobile device (2) and the server (7) communicate with one another by a data network connection such as a radio data connection.

4. The system (1) according to claim 1, wherein the at least one mobile device (2) is a mobile telephone, smartphone, tablet, notebook, laptop, smart wearables and/or mobile device specifically provided for the system (1).

5. The system (1) according to claim 1, wherein the security element SEALS-SE (3) comprises a processor with cryptographic suitability.

6. The system (1) according to claim 1, wherein the at least one mobile device (2) comprises at least one of:
a processor,
a memory,
a power supply,
a display with input field,
a mobile radio transceiver, WLAN transceiver and/or a sending/receiving unit for making contact with the server (7), as well as
a connection for the data transfer between the at least one mobile device (2) and the at least one payment terminal (5), in particular a short-distance radio transceiver, a contact-based connection, an optical connection, an acoustic connection and/or a data network connection.

7. The system (1) according claim 1, wherein the at least one payment terminal (5) comprises at least
a processor,
a memory,
a power supply,
a user interface such as a touch display, and/or a machine interface such as a USB connection,
a short distance radio transceiver, a contact-based connection, an optical connection, an acoustic connection and/or a data network connection for the data transfer between the at least one mobile device (2) and the at least one payment terminal (5), as well as
the security element SEALS-SE (3).

8. The system (1) according to claim 1, wherein at least one payment the terminal (5) includes a device (2′), wherein the device (2′) comprises the at least one mobile device (2), which is enhanced with a security element SEALS-SE (3) and software and/or hardware.

9. Electronic money (4*) for secure payment using a non-secure at least one mobile device (2), at a at least one payment terminal (5) according to a system (1), wherein;
the e-money (4*) comprises at least one load token TL (41) and, after a first payment transaction, also includes at least one spend token TS (42), which differs from the load token TL (41),
the at least one load token TL (41) is stored on the at least one mobile device (2) and comprises at least the amount of a credit of the e-money (4) stored on the device (2),
the at least one spend token TS (42) comprises at least the value of the goods of the goods purchased/sold in response to the payment transaction and possibly additional information relating to the payment transaction including information relate to the at least one mobile device (2) and the at least one payment terminal (5) involved in the payment transaction, and thus represents a payment transaction with e-money (4*) from the at least one mobile device (2) to the at least one payment terminal (5), wherein the at least one spend token TS (42) is stored at least on the at least one mobile device (2) and/or the at least one payment terminal (5), and
the current value of the e-money (4*) stored on the at least one mobile device (2) is represented by the sum of the at least one load tokens TL (41) minus the sum of the possibly the at least one spend token TS (42) preferably includes information, which allows a chronological arrangement.

10. The e-money (4*) according to claim 9, wherein the at least one load token TL (41) and the at least one spend token TS (42) are stored on the at least one mobile device (2) and the smartcard (6) for each available currency, and the history of the credits and debits in the respective currency is displayed in the order of the tokens.

11. A method for secure payment with e-money (4, 4*) using the at least one mobile device (2) with the system (1) according to claim 1, the method comprises at least one of the following steps a) to d):
a) storing the e-money (4*) on the at least one mobile device (2) and/or at least one terminal (5), wherein the e-money (4*) comprises at least one load token TL (41) and, after a first transaction, also at least one spend token TS (42),
b) paying with e-money (4, 4*) with final settlement without Internet connection at the time of the payment transaction comprising a transaction of a credit balance from at least one mobile device (2) to terminal (5) and/or from terminal (5) to device (2), wherein the terminal (5) comprises at least one physical security element SEALS-SE (3), the at least one mobile device (2) and the at least one terminal (5) communicate with one another, and the transaction of the credit balance is preferably represented in at least one spend token TS (42),
c) the exchange of at least one telegram between terminal (5) and server (7) and/or between server (7) and the at least one terminal (5), wherein the exchange of the at least one telegram takes place via the at least one mobile device (2) and/or a plurality of devices (2″), and/or
d) the monitoring and detecting of misuse in the system (1) with e-money (4, 4*), wherein
the server (7) stores, processes the telegrams received by the devices (2, 2″), possibly blocks at least one device (2, 2″) for the system (1), and transfers other telegrams via the devices (2, 2″) to the terminal (5), and/or
the terminal (5) verifies at least the spend tokens TS (42) received from the devices (2, 2″) using the security element SEALS-SE (3) with regard to the correctness thereof, possibly blocks and/or rejects at least one device (2, 2″) for the system (1), and possibly transfers at least one telegram via the devices (2, 2″) to the server (7),
e) and possibly a buy-back of the e-money (4, 4*) accumulated at the terminal (5) with money transfer to the seller's bank account.

12. A method according to claim 11, wherein the e-money (4*) includes the at least one load token TL (41) and the at least one spend token TS (42), which differs from the load token TL (41), wherein
the load token TL (41) is stored on the device (2) and comprises at least the amount of a credit of the e-money (4*) stored on the device (2),
the spend token TS (42) comprises at least the value of the goods of the goods purchased/sold in response to the payment transaction and possibly additional information relating to the payment transaction, in particular relating to the device (2) and terminal (5) involved in the payment transaction, and thus represents a payment transaction with e-money (4*) from the device (2) to the terminal (5), wherein the spend token TS (42) is stored at least on the device (2) and/or terminal (5), and
the current value of the e-money (4*) stored on the device (2) is represented by the sum of the load tokens TL (41) minus the sum of the spend tokens TS (42), wherein the at least one load token TL (41) and the possibly at least one spend token TS (42) preferably includes information, which allows a chronological arrangement.

13. The method according to claim 11, wherein the e-money (4*) stores at least one load token TL (41) and, after a first payment transaction, also at least one spend token TS (42), which differs from the load token TL (41), for each available currency on the device (2) and possibly on the smartcard (6), and wherein the at least one load token TL (41) and the at least one spend token TS (42) are preferably displayed chronologically with regard to the credits and debits in the respective currency.

14. (canceled)

15. (canceled)
